(19) United States
(12) Patent Application Publication
(10) Pub. No.: US 2007/0209854 A1
(43) Pub. Date: Sep. 13, 2007

(54) Motorized bike capable of controlling its driving direction by shifting rider's body

(76) Inventor: Yi-Hsin Ho, Sijhou Township (TW)

Correspondence Address: RABIN & BERDO, P.C., Suite 500, 1101 14th Street, N.W., Washington, DC, 20005, US

(21) Appl. No.: 11/445,308

(22) Filed: Jun. 2, 2006

(30) Foreign Application Priority Data
Mar. 7, 2006 (TW) 95203792

(51) Int. Cl. B62D 61/06

(52) U.S. Cl. 180/210

(57) ABSTRACT

The invention relates to a motorized bike comprising a front wheel steering stand pivotally coupled to the front of a bike body, a rear wheel installed at the rear of the bike body, an axle of the rear wheel for driving a sprocket engaged with a chain and a motor, a saddle disposed at the middle of the bike body, and a handle, a power switch and a brake switch disposed at the front of the saddle, such that after a rider turns on the power switch and drives the motorized bike, the driver can ride on the bike with a balance of the rider's body or shifts the body to left or right to turn the front wheel steering stand, such that the motorized bike can be turned accordingly, so as to achieve the effect of making a turn for the bike by shifting the rider's body.

### BACKGROUND OF THE INVENTION

1. Field of the Invention

The present invention relates to a motorized bike capable of controlling its driving direction by shifting a rider's body, and more particularly to a motorized bike that allows a rider to drive the bike forward by riding on the bike while maintaining a balance of the rider's body, and the rider also can make a turn by shifting the body.

2. Description of the Related Art

In general, the design of a bike usually emphasizes on the safety and convenience of riding the bike. For the increasingly high demand on modern innovative products, many stylish bikes with fantastic designs and breakthroughs are developed. However, a vast majority of the present bikes use pedals as a driving force or use electric power for driving the bike. However, these bikes are controlled by rider's both hands, and there is no significant change on the operation of the bike.

### SUMMARY OF THE INVENTION

In view of the description above, the inventor of the present invention develops and invents the invention. The primary objective of the present invention is to provide a motorized bike capable of controlling its driving direction by shifting a rider's body, wherein a front wheel steering stand is pivotally coupled to a front end of a bike body; a rear wheel is installed at a rear end of the bike body; an axle of the rear wheel can drive a sprocket engaged with a chain and a motor; a saddle disposed at the middle of the bike body; and a handle, a power switch and a brake switch are disposed at the front end of the saddle of the bike body, such that after a rider sits on the saddle of the bike body and turns on the power switch, the rider can drive the motorized bike forward while maintaining the balance of the rider's body and sitting straight. If the rider's body is shifted to a left side or a right side, then the front wheel steering stand at the front end of the bike body will be turned accordingly, so that the motorized bike can be turned to make a turn for the bike body by shifting the rider's body.

### BRIEF DESCRIPTION OF THE DRAWINGS

FIG. 1 is a schematic perspective view of a structure of the invention;

FIG. 2 is a side view of the present invention;

FIG. 3 is a front view of the present invention;

FIG. 4A is a schematic view of riding a bike of the invention;

FIG. 4B is another schematic view of riding a bike of the invention;

FIG. 5 is a schematic view of a bike going forward in a straight line according to the invention;

FIG. 6A is a schematic view of a bike making a turn in a direction according to the invention;

FIG. 6B is another schematic view of a bike making a turn in a direction according to the invention;

FIG. 7A is a schematic view of a bike making a turn in another direction according to the invention; and

FIG. 7B is another schematic view of a bike making a turn in another direction according to the invention.

### DETAILED DESCRIPTION OF THE PREFERRED EMBODIMENTS

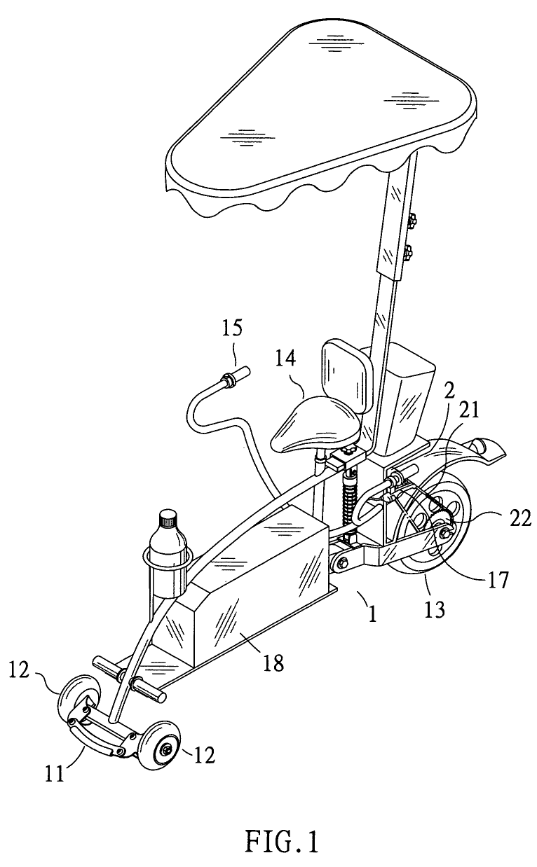

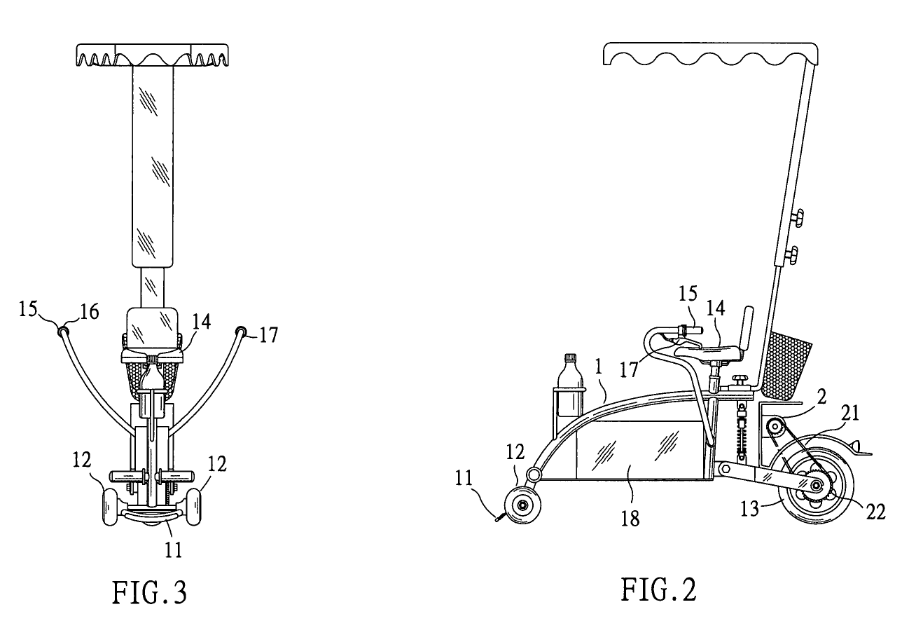

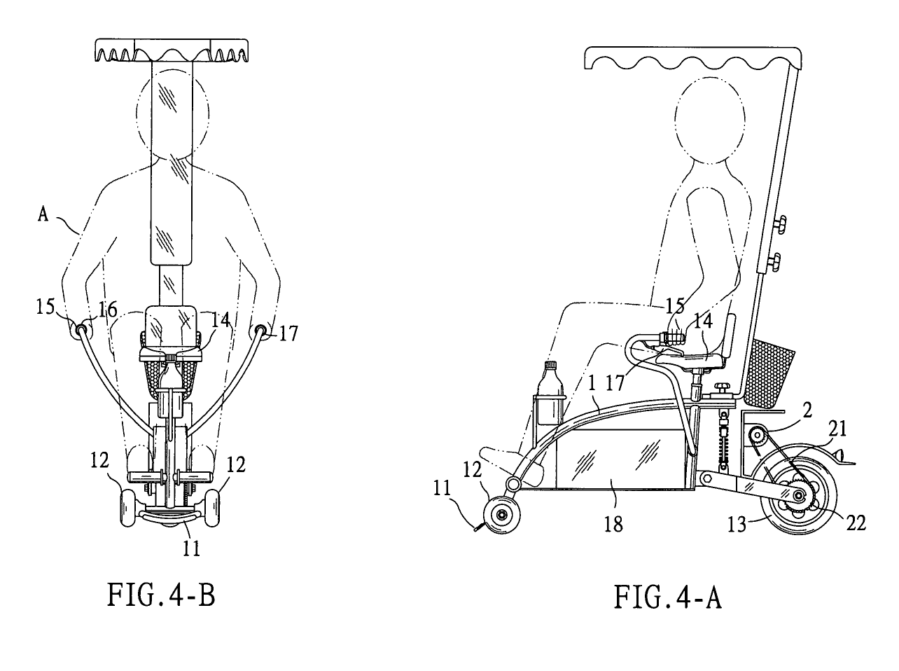

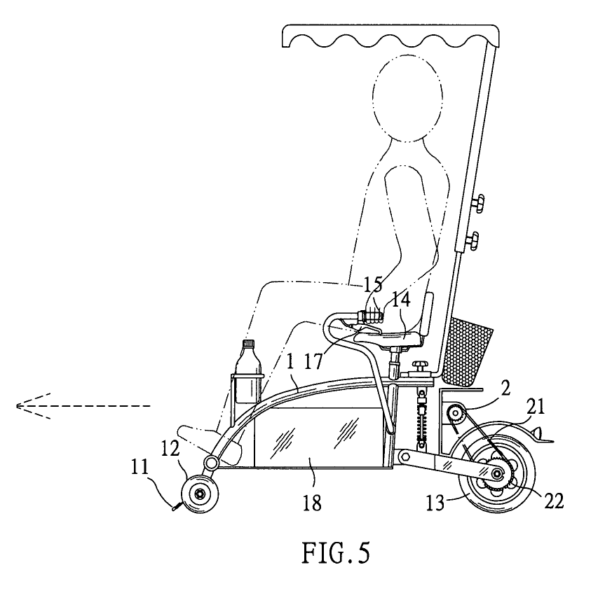

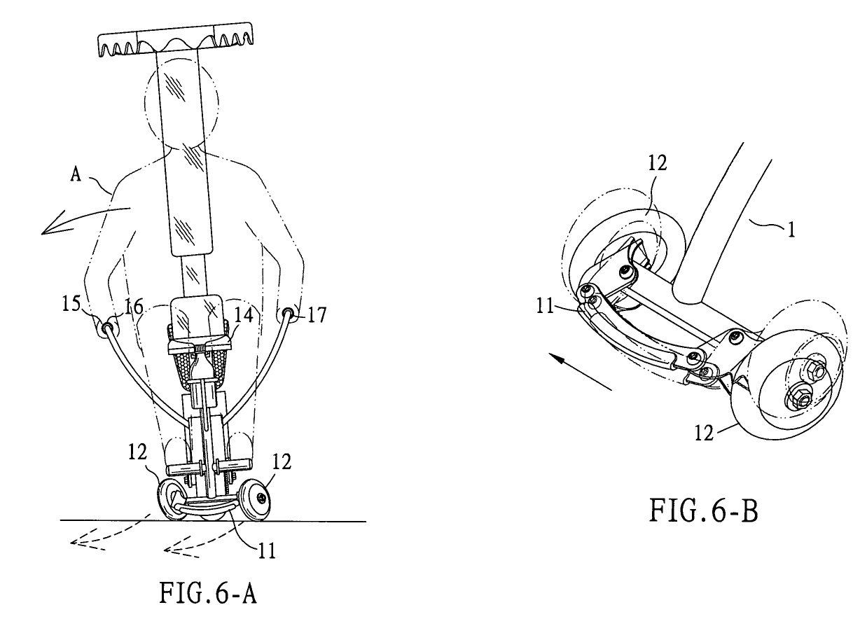

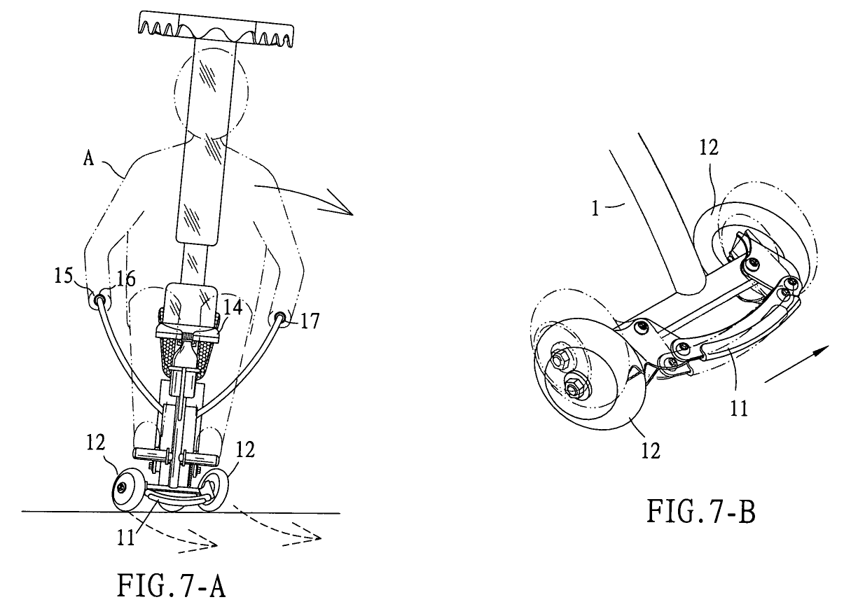

Referring to FIGS. 1 to 3 for a motorized bike capable of controlling its driving direction by shifting a rider's body according to the invention, a front wheel steering stand 11 is pivotally coupled to a bike body 1 for driving two front wheels 12 in the front wheel steering stand 11 to make a left turn or a right turn; a rear wheel 13 is installed at a rear end of the bike body, such that an axle of the rear wheel 13 drives a sprocket 22 engaged with a chain 21 and a motor 2; a saddle 14 is disposed at the middle of the bike body 1; a handle 15, a power switch 16 and a brake switch 17 are installed at the saddle 14 of the bike body 1; and a battery 18 is disposed under the bike body 1 for supplying power for the operation of the motor 2. After a rider A sits on the saddle 14 of the bike body 1 and turns on the power switch 16 (as shown in FIGS. 4A and 4B), the rear wheel 13 is driven by the motor 2 through the axle, the chain 21, and the sprocket 22, and the body balance of the rider A maintains the motorized bike to go forward in a straight line (as shown in FIG. 5). If it is necessary to stop the bike, the rider A presses on the brake switch 17. If it is necessary to make a turn, the rider A tilts and shifts the body to a left side or a right side. In other words, when the body is shifted to left or right, the front wheel steering stand 11 at the front end of the bike body 1 will be turned accordingly, and thus the front wheel 12 will be turned as well (as shown in FIGS. 6A and 6B). On the other hand, if the rider A shifts to another side, then the bike body 1 will be turned to that direction (as shown in FIGS. 7A and 7B), so as to achieve the effect of controlling the steering direction of the bike body by shifting the rider A's body.

In summation of the above description, the present invention herein enhances the performance than the conventional structure and further complies with the patent application requirements and is submitted to the Patent and Trademark Office for review and granting of the commensurate patent rights.

What is claimed is:

1. A motorized bike capable of controlling its driving direction by shifting a rider's body, comprising:
a front wheel steering stand, pivotally coupled to a front end of a bike body, for driving two front wheels installed in said front wheel steering stand to make a left turn or a right turn;
a rear wheel, installed at a rear end of said bike body and driven by an axle of said rear wheel to drive a sprocket engaged with a chain and a motor;
a saddle, disposed at the middle position of said bike body;
a handle, a power switch, and a brake switch, disposed in said bike body; and
a battery, disposed under said bike body, for supplying power for the operation of a motor;
thereby, the balance and shifting of a rider's body can be used for achieving the purpose of controlling the driving direction of said bike body.
